(19) United States
(12) Patent Application Publication
(10) Pub. No.: US 2025/0349881 A1
(43) Pub. Date: Nov. 13, 2025

(54) ELECTROLYTE COMPOSITE CONTAINING OXIDE-BASED SOLID ELECTROLYTE, METHOD OF PREPARING THE SAME, AND ALL-SOLID-STATE BATTERY CONTAINING THE SAME

(71) Applicant: ASET CO., LTD., Pyeongtaek-si (KR)

(72) Inventors: Seok-Jung PARK, Seoul (KR); So-Young YANG, Suwon-si (KR)

(21) Appl. No.: 18/771,705

(22) Filed: Jul. 12, 2024

(30) Foreign Application Priority Data
May 9, 2024 (KR) 10-2024-0061195

(51) Int. Cl. H01M 10/0562

(52) U.S. Cl. CPC H01M 10/0562; H01M 2300/0071; H01M 2300/0094

(57) ABSTRACT

The disclosure relates to an electrolyte composite containing an oxide-based solid electrolyte, a method of preparing the same, and an all-solid-state battery containing the same, and more particularly to an electrolyte composite containing an oxide-based solid electrolyte that maintains high ionic conductivity to improve the performance of an all-solid-state battery, a method of continuously preparing the electrolyte composite in a mass production manner, and an all-solid-state battery containing the electrolyte composite.

### CROSS REFERENCE TO RELATED APPLICATION

The present application claims priority to Korean Patent Application No. 10-2024-0061195, filed May 9, 2024, the entire contents of which is incorporated herein for all purposes by this reference.

### BACKGROUND OF THE INVENTION

### Field of the Invention

The disclosure relates to an electrolyte composite containing an oxide-based solid electrolyte, a method of preparing the same, and an all-solid-state battery containing the same, and more particularly to an electrolyte composite containing an oxide-based solid electrolyte that maintains high ionic conductivity to improve the performance of an all-solid-state battery, a method of continuously preparing the electrolyte composite in a mass production manner, and an all-solid-state battery containing the electrolyte composite.

### Description of the Related Art

Lithium secondary batteries have been generally applied to small-sized fields such as mobile devices or laptop computers, but have recently been studied to expand their application to medium to large-sized fields that mostly require high output in connection with energy storage systems (ESS) or electric vehicles (EV). Unlike the lithium secondary batteries for the small-sized fields, the lithium secondary batteries for the medium to large-sized fields need to ensure safety in addition to excellent performance and appropriate prices because they operate under harsh conditions such as temperature and shocks and include more cells. Most currently commercialized lithium secondary batteries use an organic liquid electrolyte of lithium salt (Li+) dissolved in a solvent, and thus have risks that the electrolyte may leak, ignite or explode.

Accordingly, development of all-solid-state batteries has recently been conducted. The all-solid-state batteries using a non-flammable solid electrolyte have an advantage of having higher thermal stability than the conventional lithium-ion batteries using the flammable organic liquid electrolyte. However, all the components in the all-solid-state battery, such as a positive electrode, a negative electrode, and an electrolyte, are in a solid state, and thus moving ions in the all-solid-state battery have higher resistance against the electrodes than those in the organic liquid electrolyte. Therefore, there is a problem that deterioration due to the resistance causes attached parts to be detached, thereby weakening a bond between the electrolyte and the electrode and lowering ionic conductivity.

In particular, an oxide-based solid electrolyte has limitations in preparing a large-area battery due to disadvantages such as high interfacial resistance against the electrode, high resistance between electrolyte particles, and high processing temperature of 1000° C. or higher. Further, when the solid electrolyte is used alone, the insufficient flexibility and high interfacial resistance thereof make it difficult to form a thin film. When polymer materials are added for the thin film, the flexibility is improved, but the conductivity of the electrolyte composite is significantly decreased, thereby lowering the energy density of the battery.

Accordingly, to commercialize the electrolyte composite for the all-solid-state battery, it is required to develop a preparation method for continuous mass production of the electrolyte composite, which can maintain the ionic conductivity high to improve the performance of the all-solid-state battery.

### SUMMARY OF THE INVENTION

An aspect of the disclosure is to provide an electrolyte composite, which is thinner than a conventional one while maintaining high ionic conductivity, a preparation method for continuous mass production of the same, and an all-solid-state battery containing the electrolyte composite.

The aspect of the disclosure is not limited to what has been described above, and other aspects and advantages not mentioned herein will be apparent from the following description to those skilled in the art. Further, it will be understood that that aspects and advantages of the disclosure may be achieved by the means set forth in claims and combinations thereof.

According to a first aspect of the disclosure, there may be provided an electrolyte composite including: a solid electrolyte green sheet; a first composite membrane laminated on a first surface of the solid electrolyte green sheet; and a second composite membrane laminated on a second surface of the solid electrolyte green sheet, the electrolyte composite having a thickness of 30 μm or less.

The electrolyte composite may exhibit an ionic conductivity of 5×10⁻⁵ S/m or more.

The solid electrolyte green sheet may have a thickness of 5 to 20 μm, and each of the first composite membrane and the second composite membrane may have a thickness of 1 to 5 μm.

The solid electrolyte green sheet may be prepared with a mixture for a green sheet, which contains a solid electrolyte and a binding agent, 100 wt % of the mixture for the green sheet may contain 60 to 95 wt % of the solid electrolyte and 5 to 40 wt % of the binding agent, and the solid electrolyte may include an ion-conductive garnet-type oxide having an average particle diameter (D₅₀) of 10 μm or less, which contains a compound represented by one of i) to iii) below:
i) Li₇₋ₓMₓLa₃Zr₂₋ₓO₁₂ (where, M is at least one selected from a group consisting of Ga, Ta, Y, Sc, Nb, Fe and Al, and x≤0.7),
ii) LiₓGa_{w}La_{y}Zr_{z}O₁₂ (where, 5≤x≤9, 2≤y≤4, 1≤z≤3, and 0≤w≤1), and
iii) LiₓGa_{w}La_{y}Zr_{z}ScₘO₁₂ (where, 5≤x≤9, 2≤y≤4, 1≤z≤3, 0≤w≤1, and 0≤m≤1).

Each of the first composite membrane and the second composite membrane may contain an ion-conductive oxide and an ion-conductive polymer, and the ion-conductive oxide may include an ion-conductive garnet-type oxide having an average particle diameter (D₅₀) of 2 μm or less, which contains a compound represented by one of i) to iii) below:
i) Li₇₋ₓMₓLa₃Zr₂₋ₓO₁₂ (where, M is at least one selected from a group consisting of Ga, Ta, Y, Sc, Nb, Fe and Al, and x≤0.7),
ii) LiₓGa_{w}La_{y}Zr_{z}O₁₂ (where, 5≤x≤9, 2≤y≤4, 1≤z≤3, and 0≤w≤1), and
iii) LiₓGa_{w}La_{y}Zr_{z}ScₘO₁₂ (where, 5≤x≤9, 2≤y≤4, 1≤z≤3, 0≤w≤1, and 0≤m≤1).

A ratio of a thickness (A) of the solid electrolyte green sheet and a thickness sum (B) of the first composite membrane and the second composite membrane, i.e., the ratio of A: B may be 1:0.2 to 1:1.5.

According to a second aspect of the disclosure, there may be provided an all-solid-state battery includes: a positive electrode; a negative electrode; and an electrolyte, wherein the electrolyte includes the electrolyte composite of the first aspect.

According to a third aspect of the disclosure, there may be provided a method of preparing an electrolyte composite, including steps of:
(S1) preparing a solid electrolyte green sheet;
(S2) preparing a first composite membrane and a second composite membrane, which contain an ion-conductive oxide and an ion-conductive polymer;
(S3) preparing a first laminate by laminating the first composite membrane on a first surface of the solid electrolyte green sheet;
(S4) impregnating and drying a second surface in the green sheet of the first laminate prepared in the step (S3), on which the first composite membrane is not laminated, with a mixture that contains a lithium salt and a plasticizer; and
(S5) obtaining the electrolyte composite with a second laminate prepared by laminating the second composite membrane on the second surface in the green sheet of the first laminate prepared in the step (S4), on which the first composite membrane is not laminated,
the electrolyte composite having a thickness of 30 μm or less.

The solid electrolyte green sheet may have a thickness of to 20 μm, and each of the first composite membrane and the second composite membrane may have a thickness of 1 to 5 μm.

A ratio of a thickness (A) of the solid electrolyte green sheet and a thickness sum (B) of the first composite membrane and 5 the second composite membrane, i.e., the ratio of A: B is 1:0.2 to 1:1.5.

The solid electrolyte green sheet in the step (S1) may be prepared with a mixture for a green sheet, which contains a solid electrolyte and a binding agent, and 100 wt % of the mixture for the green sheet may contain 60 to 95 wt % of the solid electrolyte and 5 to 40 wt % of the binding agent.

The solid electrolyte may includes an ion-conductive garnet-type oxide having an average particle diameter (D₅₀) of 10 μm or less, which contains a compound represented by one of i) to iii) below:
i) Li₇₋ₓMₓLa₃Zr₂₋ₓO₁₂ (where, M is at least one selected from a group consisting of Ga, Ta, Y, Sc, Nb, Fe and Al, and x≤0.7),
ii) LiₓGa_{w}La_{y}Zr_{z}O₁₂ (where, 5≤x≤9, 2≤y≤4, 1≤z≤3, and 0≤w≤1), and
iii) LiₓGa_{w}La_{y}Zr_{z}ScₘO₁₂ (where, 5≤x≤9, 2≤y≤4, 1≤z≤3, 0≤w≤1, and 0≤m≤1).

The binding agent may contain one or more among cellulose, polyvinylidene fluoride (PVDF), polyvinylidene fluoride-hexafluoro propylene (PVDF-HFP), polyacrylonitrile (PAN), and polyethylene oxide (PEO).

The first composite membrane and the second composite membrane in the step (S2) are prepared by applying and drying a mixture, which contains an ion-conductive oxide, an ion-conductive polymer, a lithium salt, and a plasticizer, on a release film.

The ion-conductive oxide may include an ion-conductive garnet-type oxide having an average particle diameter (D₅₀) of 2 μm or less, which contains a compound represented by one of i) to iii) below:
i) Li₇₋ₓMₓLa₃Zr₂₋ₓO₁₂ (where, M is at least one selected from a group consisting of Ga, Ta, Y, Sc, Nb, Fe and Al, and x≤0.7),
ii) LiₓGa_{w}La_{y}Zr_{z}O₁₂ (where, 5≤x≤9, 2≤y≤4, 1≤z≤3, and 0≤w≤1), and
iii) LiₓGa_{w}La_{y}Zr_{z}ScₘO₁₂ (where, 5≤x≤9, 2≤y≤4, 1≤z≤3, 0≤w≤1, and 0≤m≤1).

The ion-conductive polymer in the step (S2) may include one or more among polyvinylidene fluoride-hexafluoro propylene (PVDF-HFP), polyvinylidene fluoride (PVDF), polyacrylonitrile (PAN), polyethylene oxide (PEO), and copolymers thereof.

The lithium salt may include one or more among lithium bistrifluoromethanesulfonyl imide (LiFSI), lithium hexafluorophosphate (LiPF₆), lithium tetrafluoroborate (LiBF₄), lithium hexafluoroantimonate (LiSbF₆), lithium Hexafluoroacenate (LiAsF₆), lithium difluoromethanesulfonate (LiC₄F₉SO₃), lithium perchlorate (LiCIO₄), lithium aluminate (LiAlO₂), lithium iodide (LiI), lithium bisoxalate borate (LiB(C₂O₄)₂), and lithium trifluoromethanesulfonylimide (LiTFSI).

The plasticizer may include one or more among succinonitrile (ScN), alkylene carbonate containing 1 to 4 carbon atoms, vinylene carbonate, dimethyl carbonate, diethyl carbonate, methyl ethyl carbonate, gammabutyrolactone, sulfolane, 1,2-dimethoxyethane, 1,2-diethoxyethane, 1,2-ethoxymethoxyethane, tetrahydrofuran, 2-methyl-1,3-dioxolane, 4-methyl-1,3-dioxolane, dimethyl ether, diethyl ether, and methyl propionate.

The method may further include removing a release film for the first composite membrane after preparing the first laminate in the step (S3).

In the mixture that contains the lithium salt and the plasticizer in the step (S4), a molar ratio of the lithium salt to the plasticizer may be 1:8 to 1:30

The electrolyte composite according to the disclosure is improved in durability due to high adhesion of the green sheet and composite membrane included therein, maintains high ionic conductivity, and has small thickness and high flexibility compared to the conventional one.

When the all-solid-state battery is manufactured including the electrolyte composite according to the disclosure, the adhesion area increased due to oxide particles contained in the electrolyte composite facilitates a bi-cell assembly for coupling the positive electrode and the negative electrode, electrical resistance is reduced to improve the performance and durability of the battery, and high cell performance is exhibited at the level of secondary batteries using the liquid the electrolyte.

The method of preparing the electrolyte composite according to the disclosure has an advantage of high processing efficiency because continuous mass production of the electrolyte composite is possible.

In addition to the foregoing effects, the effects of the disclosure will be described below while describing the matters for carrying out the disclosure.

### BRIEF DESCRIPTION OF THE DRAWINGS

FIG. 1 is a schematic diagram of an electrolyte composite according to an embodiment of the disclosure.

FIG. 2 is a flow chart showing a method of preparing an electrolyte composite according to an embodiment of the disclosure.

FIG. 3 is a graph showing series resistance measurement results measured from an experimental example 1 of the disclosure.

FIG. 4 is a graph showing rate characteristic evaluation results evaluated from an experimental example 2 of the disclosure.

FIG. 5 is a graph showing initial electrochemical property evaluation results evaluated from an experimental example 3 of the disclosure.

FIG. 6 is a graph showing electrochemical property evaluation results of an all-solid-state battery according to a first embodiment evaluated in an experimental example 4 of the disclosure.

### DETAILED DESCRIPTION OF THE INVENTION

The aforementioned aspects, features, and advantages will be described in detail with reference to the accompanying drawings, so that a person having ordinary knowledge in the art to which the disclosure pertains can easily implement the inventive concept. In terms of describing the disclosure, if it is determined that a detailed description of well-known technology associated with the disclosure may blurs the gist of the disclosure, the detailed description will be omitted. Hereinafter, exemplary embodiments of the disclosure will be described in detail with reference to the accompanying drawings. In the drawings, the same reference numerals may be used to indicate the same or similar components.

When the terms “include,” “have,” “comprise,” “arrange,” “provide” and so on are used in the specification, they mean that other components may be added unless “only” is used. A singular form may include plural referents, unless specifically stated otherwise.

In terms of interpreting components in the present specification, they are interpreted as including an error range even though there are no explicit description of the error range.

In the present specification, the referenced D₅₀ particle sizes correspond to a volumetric D₅₀ value, i.e., a particle size wherein the collection of particles below the referenced D₅₀ size correspond to 50% of the total particle volume of a particular particle size distribution. This volumetric particle size distribution D₅₀ value for a particulate sample can be determined by those skilled in the art using a particle size analyzer (PSA).

Below, the disclosure will be described in more detail.

[Electrolyte composite]

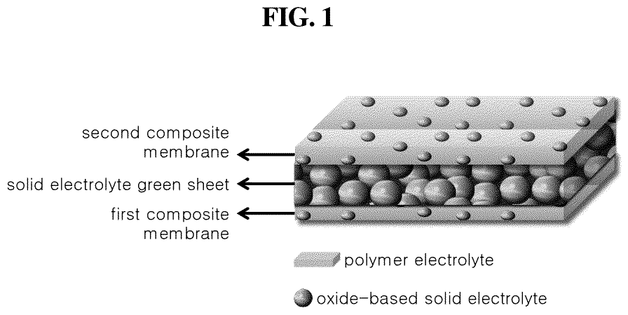

Referring to FIG. 1, an electrolyte composite according to an aspect of the disclosure has a three-layer laminate structure that includes a solid electrolyte green sheet; a first composite membrane laminated on one side of the solid electrolyte green sheet; and a second composite membrane laminated on the second surface of the solid electrolyte green sheet, and exhibits a high ionic conductivity of 5×10⁻⁵ S/m or more.

The overall thickness of the electrolyte composite may be 30 μm or less, for example 28 μm or less, for example 26 μm or less, for example 24 μm or less, for example 22 μm or less, and for example 20 μm or less. Although there is no lower limit to the thickness, the thickness may be 5 μm or more, for example 10 μm or more, or example 15 μm or more, and for example 18 μm or more.

According to an embodiment of the disclosure, the thickness of the solid electrolyte green sheet may be 5 to 20 μm, and each thickness of the first composite membrane and the second composite membrane may be 1 to 5 μm.

According to an embodiment of the disclosure, a ratio of the thickness (A) of the solid electrolyte green sheet and the thickness sum (B) of the first composite membrane and the second composite membrane, i.e., the ratio of A: B may be 1:0.2 to 1:1.5, for example 1:0.2 to 1:1, and for example 1:0.6 to 1:1.

The solid electrolyte green sheet includes a binding agent, i.e., a polymer material that serves as a binder in a solid electrolyte and a green sheet. Regarding 100 wt % of a mixture that contains the solid electrolyte and the binding agent, the mixture may include 60 to 95 wt % of the solid electrolyte and 5 to 40 wt % of the binding agent, preferably 70 to 90 wt % of the solid electrolyte and 5 to 30 wt % of the binding agent, and preferably 80 to 90 wt % of the solid electrolyte and 10 to 20 wt % of the binding agent. When the content of the binding agent is too high above the foregoing ranges, the electrochemical properties may be significantly degraded due to decrease in the ionic conductivity of the solid electrolyte green sheet. On the other hand, when the content is too low, the solid electrolyte green sheet may have poor processability and may be easily damaged by impact.

The solid electrolyte refers to an ion-conductive garnet-type oxide having an average particle diameter (D₅₀) of 10 μm or less, which may contain a compound represented by one of i) to iii) below. When the oxide particles in the solid electrolyte have an average particle diameter exceeding 10 μm, the ion transfer characteristics of the finally prepared electrolyte composite are reduced, thereby decreasing energy density and causing a limitation in making the overall thickness of the electrolyte composite thin.
i) Li₇₋ₓMₓLa₃Zr₂₋ₓO₁₂ (where, M is at least one selected from a group consisting of Ga, Ta, Y, Sc, Nb, Fe and Al, and x≤0.7),
ii) LiₓGa_{w}La_{y}Zr_{z}O₁₂ (where, 5≤x≤9, 2≤y≤4, 1≤z≤3, and 0≤w≤1), and
iii) LiₓGa_{w}La_{y}Zr_{z}ScₘO₁₂ (where, 5≤x≤9, 2≤y≤4, 1≤z≤3, 0≤w≤1, and 0≤m≤1).

The binding agent may contain one or more among cellulose, polyvinylidene fluoride (PVDF), polyvinylidene fluoride-hexafluoro propylene (PVDF-HFP), polyacrylonitrile (PAN), and polyethylene oxide (PEO).

The lithium lanthanum zirconium oxide (LLZO) solid electrolyte doped with gallium (Ga) or the like as shown in the chemical formulae i) to iii) may have one or more structures selected between a cubic structure and a tetragonal structure. Preferably, the gallium-doped LLZO may have a single-phase cubic structure, in which the cubic structure has an advantage of high ionic conductivity and excellent potential stability.

Preferably, the solid electrolyte may be (Li_{6.55}Ga_{0.25}) La₃Zr₂O₁₂ or (Li_{6.55}Ga_{0.25})La₃(Zr_{1.4}Sc_{0.1})O₁₂, but is not necessarily limited thereto.

Each of the first composite membrane and the second composite membrane contains an ion-conductive oxide and an ion-conductive polymer. The ion-conductive polymer has an ionic conductivity of about 10⁻⁶ to 10⁻⁴ S/cm, and the ion-conductive oxide has an ionic conductivity of about 10⁻⁵ to 10⁻³ S/cm. Because the ion-conductive polymer has a lower ionic conductivity than the ion-conductive oxide as above, use of only the ion-conductive polymer results in lowering the conductivity of the finally prepared electrolyte composite. Therefore, by mixing the ion-conductive polymer with the ion-conductive oxide (i.e., the electrolyte) to prepare a polymer-oxide composite membrane, the overall ionic conductivity may be improved. Further, oxide particles contained in the composite membrane cause the surface of the oxide-polymer composite membrane to be increased in roughness compared to that caused by the electrolyte membrane containing only polymers, thereby having effects on increasing an adhesion area and improving interlayer adhesion during the assembly of the electrolyte composite. With these effects, the durability and ionic conductivity of the electrolyte composite may be enhanced.

In addition, during the assembly of the all-solid-state battery, and even during a bi-cell assembly, i.e., an assembly process for a positive electrode and a negative electrode, the oxide particles increase the adhesion area of the electrolyte composite membrane, thereby having advantages of increasing the ease of assembly, and decreasing electrical resistance to increase the performance and durability of the battery.

On the other hand, when the proportion of the ion-conductive oxide is excessively high, the electrolyte composite itself is decreased in flexibility, and is thus unsuitable for continuous processing and mass production.

In this regard, a total weight (i.e., 100 wt %) of the ion-conductive oxide and the ion-conductive polymer may contain 5 to 20 wt % of the ion-conductive oxide and 80 to 95 wt % of the ion-conductive polymer, and preferably 5 to 10 wt % of the ion-conductive oxide and 80 to 90 wt % of the ion-conductive polymer.

The ion-conductive oxide refers to an ion-conductive garnet-type oxide having an average particle diameter (D₅₀) of 2 μm or less, which may contain a compound represented by one among of i) to iii) below. When the average particle diameter (D₅₀) of the ion-conductive oxide is 2 μm or less, it is advantageous to improve the ionic conductivity and prepare the composite membrane having a thin thickness of 5 μm or less.

i) Li₇₋ₓMₓLa₃Zr₂₋ₓO₁₂ (where, M is at least one selected from a group consisting of Ga, Ta, Y, Sc, Nb, Fe and Al, and x≤0.7),

ii) LiₓGa_{w}La_{y}Zr_{z}O₁₂ (where, 5≤x≤9, 2≤y≤4, 1≤z≤3, and 0≤w≤1),

iii) LiₓGa_{w}La_{y}Zr_{z}ScₘO₁₂ (where, 5≤x≤9, 2≤y≤4, 1≤z≤3, 0≤w≤1, 0≤m≤1).

The ion-conductive oxide may be selected to be the same as or different from the solid electrolyte contained in the solid electrolyte green sheet, but may have a smaller size than the solid electrolyte, i.e., have an average particle diameter (D₅₀) of 2 μm or less. The description about the ion-conductive oxide is the same as described above in connection with i) to iii) of the solid electrolyte except the average particle diameter (D₅₀).

The ion-conductive polymer may include one or more among polyvinylidene fluoride-hexafluoro propylene (PVDF-HFP), polyvinylidene fluoride (PVDF), polyacrylonitrile (PAN), polyethylene oxide (PEO), and copolymers thereof, but is not limited thereto. With the ion-conductive polymer, it is advantageous to significantly lower the interfacial resistance against the positive electrode or negative electrode.

The first composite membrane and the second composite membrane may further include a lithium salt and a plasticizer in addition to the ion-conductive oxide and the ion-conductive polymer.

The lithium salt may include one or more among lithium bistrifluoromethanesulfonyl imide (LiFSI), lithium hexafluorophosphate (LiPF₆), lithium tetrafluoroborate (LiBF₄), lithium hexafluoroantimonate (LiSbF₆), lithium Hexafluoroacenate (LiAsF₆), lithium difluoromethanesulfonate (LiC₄F₉SO₃), lithium perchlorate (LiClO₄), lithium aluminate (LiAlO₂), lithium iodide (LiI), lithium bisoxalate borate (LiB(C₂O₄)₂), and lithium trifluoromethanesulfonylimide (LiTFSI), but is not limited thereto.

The plasticizer may include one or more among succinonitrile (ScN), alkylene carbonate containing 1 to 4 carbon atoms, vinylene carbonate, dimethyl carbonate, diethyl carbonate, methyl ethyl carbonate, gammabutyrolactone, sulfolane, 1,2-dimethoxyethane, 1,2-diethoxyethane, 1,2-ethoxymethoxyethane, tetrahydrofuran, 2-methyl-1,3-dioxolane, 4-methyl-1,3-dioxolane, dimethyl ether, diethyl ether, and methyl propionate, but is not limited thereto.

In this way, the oxide and the composite membrane (i.e., the first and second composite membranes) in the solid electrolyte include the oxide and the polymer, respectively, and the average particle diameter and the proportion of the oxide are adjusted variously, thereby improving both the durability and the flexibility of the electrolyte composite in a finally prepared three-layered structure while improving the ionic conductivity.

### [Method of Preparing Electrolyte Composite]

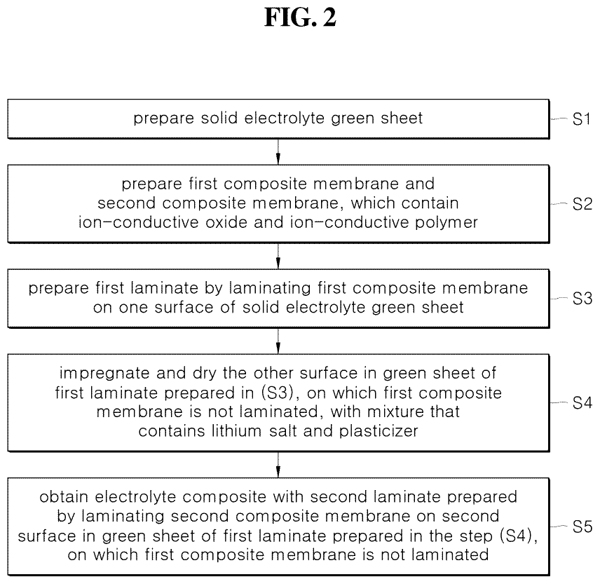

Referring to FIG. 2, a method of preparing an electrolyte composite according to another aspect of the disclosure may include the following steps, while satisfying the thickness of 30 μm or less:
(S1) preparing a solid electrolyte green sheet;
(S2) preparing a first composite membrane and a second composite membrane, which contain an ion-conductive oxide and an ion-conductive polymer;
(S3) preparing a first laminate by laminating the first composite membrane on a first surface of the solid electrolyte green sheet;
(S4) impregnating and drying a second surface in the green sheet of the first laminate prepared in the step (S3), on which the first composite membrane is not laminated, with a mixture that contains a lithium salt and a plasticizer; and
(S5) obtaining the electrolyte composite with a second laminate prepared by laminating the second composite membrane on the second surface in the green sheet of the first laminate prepared in the step (S4), on which the first composite membrane is not laminated.

An electrolyte composite prepared by a method of preparing the electrolyte composite according to another aspect of the disclosure satisfies the above-described characteristics. The foregoing descriptions about the ingredients, content, thickness, etc. of the electrolyte composite according to the disclosure are equally applied to the following method of preparing the electrolyte composite, and thus repetitive descriptions thereof will be omitted or briefly explained.

### Step S1

In the step S1, the solid electrolyte green sheet may be prepared with a mixture for the green sheet containing the solid electrolyte and the binding agent. Based on 100 wt % of the mixture for the green sheet, 60 to 95 wt % of the solid electrolyte and 5 to 40 wt % of the binding agent may be contained.

To prepare the solid electrolyte green sheet, the mixture for the green sheet may be prepared as a slurry as being mixed in a dispersion solvent, and the slurry is casted onto a release film and dried.

The dispersion solvent may for example include, but not particularly limited to, ketone-based solvents such as acetone, methyl ethyl ketone, dipropyl ketone, and diisobutyl ketone; acetate-based solvents such as ethyl acetate, propyl acetate, butyl acetate, and propylene glycol methyl ether acetate; alcohol-based solvents such as methanol, ethanol, isopropanol, and butanol; aromatic hydrocarbon-based solvents such as toluene and xylene; ester-based solvents such as methyl propionate, ethyl propionate, butyl propionate, methyl butanoate, ethyl butanoate, butyl butanoate, methyl pentanoate, ethyl pentanoate, butyl pentanoate, methyl hexanoate, ethyl hexanoate, butyl hexanoate, 2-ethylhexyl acetate, 2-ethylhexyl butyric acid; etc., and one of these solvents or a mixed solvent of two or more of these solvents may be used.

The solid electrolyte refers to an ion-conductive garnet-type oxide having an average particle diameter (D₅₀) of 10 μm or less, which may contain a compound represented by one of i) to iii) below.

i) Li₇₋ₓMₓLa₃Zr₂₋ₓO₁₂ (where, M is at least one selected from a group consisting of Ga, Ta, Y, Sc, Nb, Fe and Al, and x≤0.7),

ii) LiₓGa_{w}La_{y}Zr_{z}O₁₂ (where, 5≤x≤9, 2≤y≤4, 1≤z≤3, and 0≤w≤1), and

iii) LiₓGa_{w}La_{y}Zr_{z}ScₘO₁₂ (where, 5≤x≤9, 2≤y≤4, 1≤z≤3, 0≤w≤1, and 0≤m≤1).

The binding agent may include one or more of cellulose, polyvinylidene fluoride (PVDF), polyvinylidene fluoride (PVDF-HFP), polyacrylonitrile (PAN) and polyethylene oxide (PEO).

### Step S2

The step S2 refers to a step of preparing the first composite membrane and the second composite membrane. According to an embodiment of the disclosure, the first composite membrane and the second composite membrane may be prepared by applying and drying a mixture of the ion-conductive oxide, the ion-conductive polymer, the lithium salt, and the plasticizer on the release film.

For instance, the mixture for preparing the first composite membrane and the second composite membrane may be mixed in a solvent and prepared as a slurry, and casted and dried on the release film. The solvent may for example include, but not particularly limited to, ketone-based solvents such as acetone, methyl ethyl ketone, dipropyl ketone, and diisobutyl ketone; acetate-based solvents such as ethyl acetate, propyl acetate, butyl acetate, and propylene glycol methyl ether acetate; alcohol-based solvents such as methanol, ethanol, isopropanol, and butanol; aromatic hydrocarbon-based solvents such as toluene and xylene; ester-based solvents such as methyl propionate, ethyl propionate, butyl propionate, methyl butanoate, ethyl butanoate, butyl butanoate, methyl pentanoate, ethyl pentanoate, butyl pentanoate, methyl hexanoate, ethyl hexanoate, butyl hexanoate, 2-ethylhexyl acetate, 2-ethylhexyl butyric acid; etc., and one of these solvents or a mixed solvent of two or more of these solvents may be used.

According to an embodiment of the disclosure, based on a total weight (i.e., 100 wt %) of the ion-conductive oxide and the ion-conductive polymer, the ion-conductive oxide may be contained in a range of 5 to 20 wt %, and the ion-conductive polymer may be contained in a range of 80 to 95 wt %. In addition, based on the total weight (i.e., 100 wt %) of the ion-conductive oxide and the ion-conductive polymer, 50 to 300 100 wt % of a mixed solution of the lithium salt and the plasticizer may be added.

The mixture for preparing the composite membranes may be coated on the release film using a slot die, a comma coater, and a dispenser. To prevent the mixture for preparing the composite membranes from curing, the mixture may be applied to the release film at a temperature of 50 to 200° C. or below and dried at a temperature of 40 to 60° C.

In the step S2, the ion-conductive oxides contained in the first composite membrane and the second composite membrane may be the same as or different from each other, and refer to the ion-conductive garnet-type oxide having an average particle diameter (D₅₀) of 2 μm or less, which may contain a compound represented by one among of i) to iii) below.

i) Li₇₋ₓMₓLa₃Zr₂₋ₓO₁₂ (where, M is at least one selected from a group consisting of Ga, Ta, Y, Sc, Nb, Fe and Al, and x≤0.7),

ii) LiₓGa_{w}La_{y}Zr₂₀₁₂ (where, 5≤x≤9, 2≤y≤4, 1≤z≤3, and 0≤w≤1), and

iii) LiₓGa_{w}La_{y}Zr₂Scₘ012 (where, 5≤x≤9, 2≤y≤4, 1≤z≤3, 0≤w≤1, and 0≤m≤1).

In the step S2, the ion-conductive polymer may include polyvinylidene fluoride-hexafluoro propylene (PVDF-HFP), polyvinylidene fluoride (PVDF), polyacrylonitrile (PAN), polyethylene oxide (PEO), and one or more copolymers thereof.

The lithium salt may include one or more among lithium bistrifluoromethanesulfonyl imide (LiFSI), lithium hexafluorophosphate (LiPF₆), lithium tetrafluoroborate (LiBF₄), lithium hexafluoroantimonate (LiSbF₆), lithium Hexafluoroacenate (LiAsF₆), lithium difluoromethanesulfonate (LiC₄F₉SO₃), lithium perchlorate (LiCIO₄), lithium aluminate (LiAlO₂), lithium tetrachloroaluminate (LiAlCl₄), lithium chloride (LiCl), lithium iodide (LiI), lithium bisoxalate borate (LiB(C₂O₄)₂), and lithium trifluoromethanesulfonylimide (LiTFSI).

The plasticizer may include one or more among succinonitrile (ScN), alkylene carbonate containing 1 to 4 carbon atoms, vinylene carbonate, dimethyl carbonate, diethyl carbonate, methyl ethyl carbonate, gammabutyrolactone, sulfolane, 1,2-dimethoxyethane, 1,2-diethoxyethane, 1,2-ethoxymethoxyethane, tetrahydrofuran, 2-methyl-1,3-dioxolane, 4-methyl-1,3-dioxolane, dimethyl ether, diethyl ether, and methyl propionate.

### Step S3

In the step S3, the preparation of the first laminate by laminating the first composite membrane on the first surface of the solid electrolyte green sheet may be for example performed in such a manner that the first composite membrane and the solid electrolyte green sheet are continuously pressed and laminated through roll lamination.

In this case, to increase the interfacial adhesion between the first composite membrane and the solid electrolyte green sheet, temperature and pressure may be set appropriately. Preferably, the roll may have a temperature of 30 to 90° C. and a pressure of 5 to 30 MPa. Further, for the ease of preparing the first laminate, the area of the first composite membrane may be larger than the area of the solid electrolyte green sheet.

According to an embodiment of the disclosure, the step S3 may further include removing the release film for the first composite membrane after preparing the first laminate.

### Step S4

In the step S4, the second surface, on which the first composite membrane is not laminated, in the green sheet of the first laminate prepared in the step S3 is impregnated with the mixture that contains the lithium salt and the plasticizer, thereby optimizing the electrochemical properties of the solid electrolyte.

The lithium salt and the plasticizer used in the step S4 are the same as those described in the step S2, but the lithium salt and the plasticizer used in step S4 may be respectively selected independently of those used in the step S2, and may be selected to be the same as or different from those used in the step S2.

When the content of the lithium salt is too low in the mixture of the lithium salt and the plasticizer, the electrochemical properties are not sufficiently exhibited. On the other hand, when the content of the lithium salt it is too high, the plasticizer is not sufficient and the lithium salt has a low degree of dissociation, thereby lowering ionic conductivity. Characteristics may be lowered. In this respect, a molar ratio of lithium salt to plasticizer may be 1:8 to 1:30, and for example, 1:10 to 1:20. The impregnation may use spray coating or the like, and may for example be applied at 3 to 20 μL/cm³, and for example 3 to 10 μL/cm³.

The mixture of the lithium salt and the plasticizer may be applied at a temperature of 50 to 100° C. so as not to be cured before the impregnation.

The details of the lithium salt and the plasticizer are the same as those described in the step S2.

### Step S5

In the step S5, the second laminate is prepared by laminating the second composite membrane on the second surface, on which the first composite membrane is not laminated, in the green sheet of the first laminate prepared in the step S4, thereby obtaining the electrolyte composite.

After the impregnation with the mixture of the lithium salt and the plasticizer in the step S4, the second composite membrane may be laminated.

The process of forming the second laminate, i.e., the electrolyte composite, by laminating the second composite membrane on the solid electrolyte green sheet of the first laminate impregnated with the mixture of the lithium salt and the plasticizer may be performed by a pressure lamination process using the roll lamination.

The lamination process may be performed, for example, at a temperature of 30 to 90° C. and a pressure of 5 to 30 MPa for a period of time of 1 to 20 minutes. When the pressure is lower than 5 to 30 MPa, a three-layered lamination may not be properly formed or the interlayer adhesion may be insufficient. When the pressure is higher than 5 to 30 MPa, the solid electrolyte green sheet may be damaged or the impregnated mixture of the lithium salt and the plasticizer may leak.

According to an embodiment of the disclosure, the step S5 may further include removing the release film for the second composite membrane after preparing the second laminate.

In this way, the preparation process for the electrolyte composite according to the disclosure employs the ion-conductive oxide (i.e., the solid electrolyte), but does not necessarily involve high-temperature processes such as calcination in itself, thereby being efficient in terms of energy and preventing a problem such as damage to the solid electrolyte, i.e., the ion conductive oxide.

[all-Solid-State Battery with Electrolyte Composite]

According to another aspect of the disclosure, an all-solid-state battery includes a positive electrode; a negative electrode; and an electrolyte, wherein the electrolyte is the electrolyte composite according to the aspect of the disclosure.

Each of the positive electrode and the negative electrode is formed including a current collector, and an electrode layer formed on one surface of the current collector. The electrode layer may include an electrode active material, a binder resin, and a conductive material, and may further include a solid electrolyte.

In the case of the positive electrode, the electrode active material may include compounds such as lithium iron phosphate (LiFePO₄), lithium nickel cobalt manganese composite oxide (common NCM active materials), lithium manganese composite oxides (LiMnO₂, LiMnO₄, etc.), lithium cobalt oxides (LiCoO₂), lithium nickel oxide (LiNiO₂), etc., but is not limited thereto.

In the case of the negative electrode, the electrode active material may include lithium metal oxides; carbon such as non-graphitizable carbon, and graphite-based carbon; metal complex oxides such as LiₓFe₂O₃ (0≤x≤1), LiₓWO₂ (0≤x≤1), SnₓMe₁₋ₓMe′_{y}O_{z} (where, Me is Mn, Fe, Pb and Ge, Me′ is Al, B, P, Si, elements from groups 1, 2 and 3 of the periodic table, and halogen, 0≤x≤1, 1≤y≤3, and 1≤z≤8); lithium metal; lithium alloy;

silicon-based alloy; tin-based alloy; metal oxides such as Sno, SnO2, Pbo, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; Li—Co —Ni based materials; titanium oxide; or a mixture of two or more thereof, but is not limited thereto.

The binder may be used for the electrode, and the binder may include one selected among polyvinylidene fluoride, polyethylene oxide, polypropylene oxide, polystyrene, polyetherimide, polyethersulfone, polysiloxane, polysulfone, polyphenylene oxide, polyhexafluoropropylene, polyacrylonitrile, and polymethyl methacrylate, a mixture of two or more thereof, or a copolymer of two or more thereof. Preferably, the binder may include one selected among polyvinylidene fluoride-hexafluoropropylene (PVDF-HFP) composite porous polymer, PVDF, and a copolymer thereof, but is not limited thereto.

The conductive material may include, for example, one or more conductive materials selected among graphite, carbon black, carbon fiber or metal fiber, metal powder, conductive whisker, conductive metal oxide, activated carbon, and polyphenylene derivatives. In more detail, the conductive material may include one or more conductive materials among natural graphite, artificial graphite, super-p, acetylene black, Ketjen black, channel black, furnace black, lamp black, summer black, denka black, aluminum powder, nickel powder, zinc oxide, potassium titanate, and titanium oxide, but is not limited thereto.

The current collector is not particularly limited as long as it has high conductivity without causing chemical changes in the all-solid-state battery, and may include, for example, stainless steel, copper, aluminum, nickel, titanium, calcined carbon, or aluminum or stainless steel, the surface of which is treated with carbon, nickel, titanium, silver, etc., but is not limited thereto.

The advantages and features of the disclosure, and methods for achieving them, will become clear by referring to the embodiments described in detail below. However, the disclosure is not limited to the embodiments disclosed below and will be implemented in various different forms. These embodiments are provided merely to ensure that the disclosure is complete and to fully inform a person, who has ordinary knowledge in the art to which the disclosure pertains, of the scope of the invention, and the disclosure is only defined by the scope of the claims.

### Embodiment 1

### 1) Preparation of First Composite Membrane and Second Composite Membrane

The composite membrane, i.e., an oxide-polymer electrolyte membrane that contain PVDF-HFP as the ion-conductive polymer, was prepared as follows.

LiTFSI for the lithium salt and ScN for the plasticizer were mixed at a molar ratio of 1:19 and stirred for 12 hours. Then, 1.5 g of PVDF-HFP for the ion-conductive polymer and 2.5 g of LiTFSI/ScN for the lithium salt-plasticizer mixture were added to acetone for the solvent, and stirred at 80° C. for 12 hours, and then a slurry prepared by adding 0.17 g of LGLZO (Li_{6.25}Ga_{0.25}La₃Zr₂O₁₂) oxide powder having a particle size (D₅₀) of 2 μm or less was mixed at 80° C. for 12 hours.

The uniformly mixed slurry solution was casted using a bar blade on the release film (e.g., the polyimide film) and dried at 50° C.

The dried composite membrane had a thickness of 5 μm, and the dried composite membrane was punched to have an area of 16 pi and stored in a vial to prevent ScN from evaporating.

Two identical composite membranes were prepared and used as the first composite membrane and the second composite membrane, respectively.

### 2) Preparation of Solid Electrolyte Green Sheet

LGLZO (Li_{6.25}Ga_{0.25}La₃Zr₂O₁₂) powder, i.e., the solid electrolyte having a particle size (D₅₀) of 10 μm or less, and cellulose were mixed at a weight ratio of 8:2 in a dispersion solvent (i.e., a mixed solvent of ethanol and propyl acetate), thereby preparing the slurry for the solid electrolyte green sheet.

The slurry for the green sheet was casted on the release film (e.g., the polyimide film) using a bar blade and dried at 60° C. After drying, the solid electrolyte green sheet had a thickness of 20 μm.

### 3) Preparation of Electrolyte Composite

The first composite membrane was placed on the first surface of the solid electrolyte green sheet prepared as above in 2), and attached using the roll lamination. In this case, the surface of the first composite membrane to be attached refers to a surface where the release film is not present. Then, the release film attached to the first composite membrane and the solid electrolyte green sheet was removed. A mixed solution of LiTFSI, i.e., the lithium salt and ScN, i.e., the plasticizer (at a molar ratio of 1:19) was applied to the surface of the solid electrolyte green sheet, from which the release film had been removed, and the solid electrolyte green sheet was impregnated with that mixed solution.

Next, the second composite membrane was placed on the solid electrolyte green sheet impregnated with the solution of LiTFSI, i.e., the lithium salt and ScN, i.e., the plasticizer, and then thermally bonded and laminated using the roll lamination, thereby preparing the second laminate. Then, the release film for the second composite membrane was removed to prepare the electrolyte composite (with a thickness of 30 μm).

The prepared electrolyte composite was punched to have an area of 18 pi.

4) Preparation of all-Solid-State Battery

The positive electrode (with an area of 14 pi), the electrolyte composite (with an area of 18 pi) prepared in 3) and the negative electrode (with an area of 16 pi) are stacked in sequence to manufacture an all-solid-state battery in the form of a 2032-type coin cell.

The composition of the positive electrode was as shown in the following Table 1, and Li was used as the negative electrode.

TABLE 1

| | | | | |
|---|---|---|---|---|
| Composition | Active material | Conductive | Binder | Solvent |
| | | material | | |
| | NCM | Carbon black | PVDF | NMP |
| | 94 wt % | 3 wt % | 3 wt % | — |
| Electrode | Loading amount | Electrode | | |
| | | area | | |
| specifications | 3.0 mg/cm² | 14 pi | | |

※ In Table 1, the solvent was excluded from the composition because it is removed after drying

### Comparative Example 1

1) Preparation of Polymeric Electrolyte Membrane (without Ion-Conductive Oxide)

LiTFSI and ScN were mixed at a molar ratio of 1:19 and stirred for 12 hours. Next, 1.5 g of PVDF-HFP and 2.5 g of LiTFSI/ScN were added to an acetone solution and stirred at 80° C. for 12 hours, and then the mixed solution was casted on the release film (e.g., the polyimide film) using a bar blade and dried at 50° C. The dried polymer electrolyte membrane had a thickness of 20 μm.

### 2) Preparation of Electrolyte Green Sheet

The electrolyte green sheet was prepared in the same manner as 2) of the embodiment 1 except having a thickness of 60 μm.

The electrolyte composite (with a thickness of 100 μm) and the all-solid-state battery according to the comparative example 1 were prepared by performing 3) and 4) in the same manner as those of the embodiment 1.

### Comparative Example 2

1) Preparation of Polymeric Electrolyte Membrane (without Ion-Conductive Oxide)

LiTFSI and ScN were mixed at a molar ratio of 1:19 and stirred for 12 hours. Next, 1.5 g of PVDF-HFP and 2.5 g of

LiTFSI/ScN were added to an acetone solution and stirred at 80° C. for 12 hours, and then the mixed solution was casted on the release film (e.g., the polyimide film) using a bar blade and dried at 50° C. The dried polymer electrolyte membrane had a thickness of 5 μm.

### 2) Preparation of Electrolyte Green Sheet

The electrolyte green sheet was prepared in the same manner as 2) of the embodiment 1 to have a thickness of 20 μm.

The electrolyte composite (with a thickness of 30 μm) and the all-solid-state battery according to the comparative example 2 were prepared by performing 3) and 4) in the same manner as those of the embodiment 1.

The major differences between the embodiment 1, the comparative example 1, and the comparative example 2 are as shown in the following Table 2.

TABLE 2

| | | Thickness of | |
|---|---|---|---|
| | First and second | solid | Thickness of |
| | composite membranes | electrolyte | electrolyte |
| | (each thickness) | green sheet | composite |
| Embodiment 1 | oxide-polymer electrolyte | 20 μm | 30 μm |
| | membrane (5 μm) | | |
| Comparative | Polymeric electrolyte | 60 μm | 100 μm |
| example 1 | membrane (20 μm) | | |
| Comparative | Polymeric electrolyte | 20 μm | 30 μm |
| example 2 | membrane (5 μm) | | |

### [Comparative Example 3] Preparation of Liquid Electrolyte Battery

1M LiPF₆ (EC: DEC=1: 1 vol % with FEC 3 wt %) was prepared as a liquid electrolyte. A battery using the liquid electrolyte was manufactured in the form of a 2032-type coin cell as a positive electrode (14 pi), a polymer (PVDF-HFP) electrolyte membrane (18 pi), and a negative electrode (16 pi) are stacked in sequence and sufficiently filled with the liquid electrolyte. Here, the positive electrode was the same as that used in 4) of the embodiment 1, and the negative electrode was made of Li.

### [Experimental Example 1] Ionic Conductivity of Electrolyte Composite

The impedance (series resistance) and the ionic conductivity (S/cm) of the electrolyte composite prepared according to the embodiment 1, the comparative example 1 and the comparative example 2 were measured and tabulated in the following Table 3.

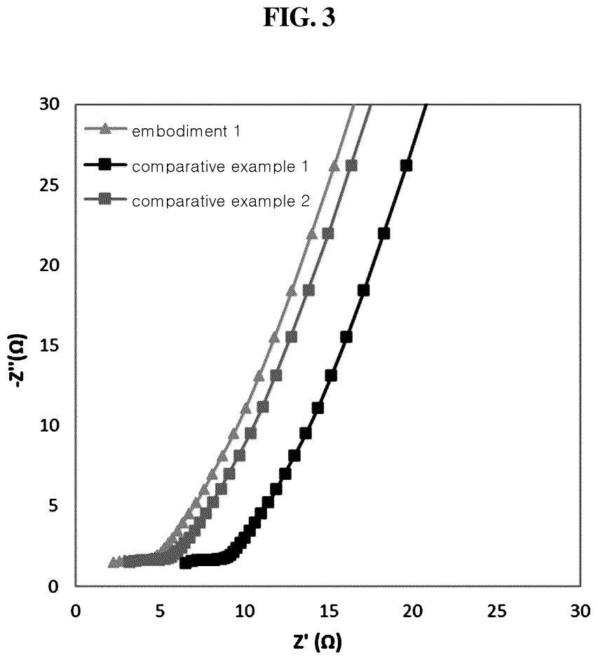

FIG. 3 shows the measurement results of the impedance (series resistance) according to the experimental example 1. Impedance refers to an element that impedes the flow of electrons in an alternating current (AC) circuit, and the value of the impedance is generally expressed in the form of a complex number. In this case, a graph (Nyquist plot) is plotted by plotting a real part of the impedance on the horizontal axis (Z′ (Ω)) and an imaginary part on the vertical axis (−Z″ (Ω)), and changes in elements that make up the impedance may be confirmed through the Nyquist plot.

The comparative example 1 shows a series resistance of 6.54 Ω, which is higher than that (2.25 Ω) of the embodiment 1 and that (3.24 Ω) of the comparative example 2, but shows the highest ionic conductivity when the thickness of 100 μm is taken into account.

Although the composite-based electrolyte membranes prepared in the embodiment 1 and the comparative example 2 have the same thickness of 30 μm, the electrolyte composite of the embodiment 1 has higher ionic conductivity than that of the comparative example 2 because the electrolyte composite of the embodiment 1 is increased in roughness on the surface of the oxide-polymer composite membrane and improved in the interlayer adhesion due to increase in the adhesion area compared to the polymeric electrolyte membrane

For reference, the ionic conductivity of the electrolyte composite membrane generally tends to increase as its thickness decreases. However, the thin electrolyte composite membrane of 30 μm or less does not have the entirely consistent tendency for the ionic conductivity to increase as the thickness decreases, because its series resistance was very small.

TABLE 3

| | | Thickness of | Thickness | Impedance | |
|---|---|---|---|---|---|
| | First and second | solid | of | (Series | Ionic |
| | composite membranes | electrolyte | electrolyte | resistance, | conductivity |
| | (each thickness) | green sheet | composite | Ω) | (S/cm) |
| Embodiment 1 | oxide-polymer | 20 μm | 30 μm | 2.25 | 0.665 × 10⁻³ |
| | electrolyte membrane | | | | |
| | (5 μm) | | | | |
| Comparative | Polymeric electrolyte | 60 μm | 100 μm | 6.54 | 0.760 × 10⁻³ |
| example 1 | membrane (20 μm) | | | | |
| Comparative | Polymeric electrolyte | 20 μm | 30 μm | 3.24 | 0.460 × 10⁻³ |
| example 2 | membrane (5 μm) | | | | |

### Experimental Example 2

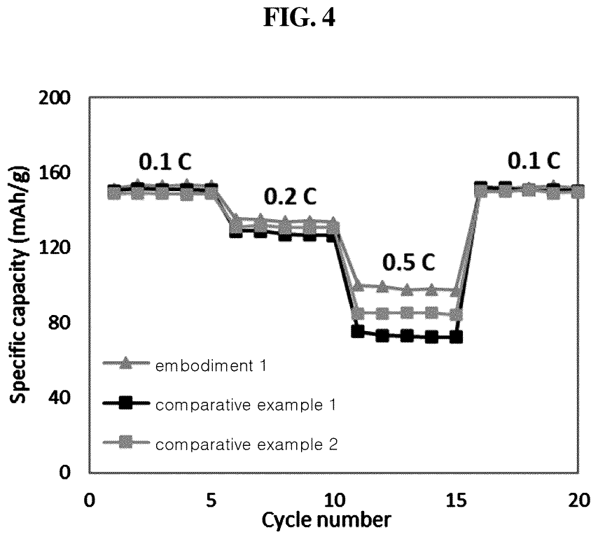

The rate characteristics of the all-solid-state batteries prepared according to the embodiment 1, the comparative example 1 and the comparative example 2 were evaluated, and the evaluation results were shown in FIG. 4, in which the horizontal axis indicates cycle numbers, and the vertical axis indicates specific capacity.

At a rate of 0.1 C, the embodiment 1, the comparative example 1 and the comparative example 2 all exhibited similar performance. However, as the rate increased, the discharge capacity of the comparative examples 1 and 2 was significantly decreased compared to that of the embodiment 1.

In the comparative example 1, the thickness of the electrolyte composite is so large that the movement path of Li ions is long even though the ionic conductivity is high compared to the thickness of the electrolyte composite. Therefore, at a high rate, the performance of the comparative example 1 is lower than those of the embodiment 1 and the comparative example 2 in which the electrolyte composite has a thickness of 30 μm.

In comparison between the embodiment 1 and the comparative example 2 of which the electrolyte composites have the same thickness, the electrolyte composite prepared in the embodiment 1 exhibited relatively high performance at a high rate because the interfacial resistance decreases the adhesion as characteristics between the electrode and the electrolyte membrane and between the electrolyte membranes are improved due to the roughness increased by the oxide particles of the oxide-polymer composite membrane.

### [Experimental Example 3] Comparison in Initial Electrochemical Characteristics Between Battery with Liquid Electrolyte and Battery with Electrolyte Composite

The initial cycles (2nd cycles) of the batteries prepared in the embodiment 1 and the comparative example 3 will be compared. The all-solid-state battery using the electrolyte

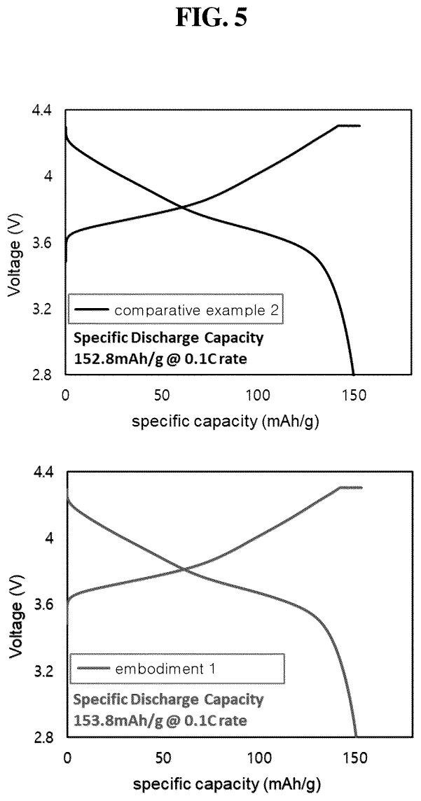

composite of the embodiment 1 exhibited an initial discharge capacity of 153.8 mAh/g, and the battery using the liquid electrolyte of the comparative example 3 exhibited an initial discharge capacity of 152.8 mAh/g (see FIG. 5). In FIG. 5, the 0.1C rate is the measurement rate, the line from the lower left to the upper right means change in voltage during a charging process, and the line from the upper left to the lower right means change in voltage during a discharging process.

Referring to the results shown in FIG. 5, the all-solid-state battery using the electrolyte composite prepared according to the embodiment 1 of the disclosure exhibited high cell performance at the level of secondary batteries using the liquid electrolyte.

### [Experimental Example 4] Electrochemical Properties of all-Solid-State Battery with Electrolyte Composite

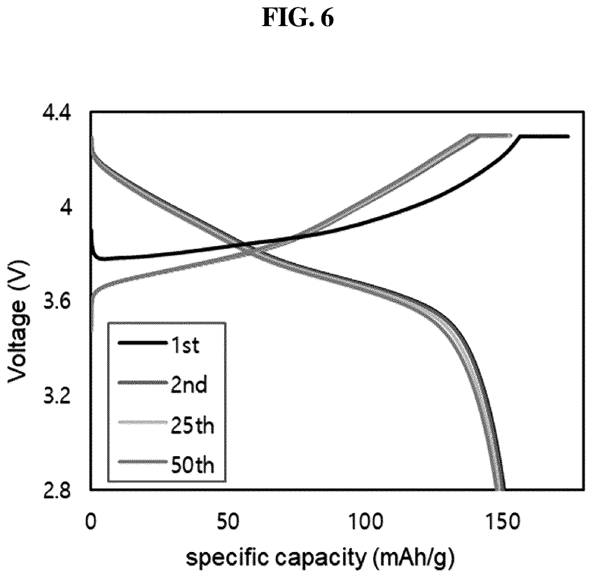

The charging and discharging characteristics according to the cycles of the all-solid-state battery with the electrolyte composite prepared in the embodiment 1 were evaluated, and the evaluation results were shown in FIG. 6. In FIG. 6, the line from the lower left to the upper right means change in voltage during the charging process, and the line from the upper left to the lower right means change in voltage during the discharging process.

Referring to FIG. 6, the initial (1^{st}) discharge capacity was 153.8 mAh/g, the discharge capacity at 50 cycles was 151.3 mAh/g, and the capacity maintenance rate was 98.4%, thereby exhibiting the excellent cycle characteristics.

The present specification is not necessarily limited to these embodiments, and various modifications may be made without departing from the technical spirit of the present specification. Accordingly, the embodiments in disclosed the present specification are not intended to limit the technical spirit of the present specification but to specifically describe it, and the scope of the technical spirit of the present specification is not limited by these embodiments. Therefore, the embodiments described above should be understood in all respects as illustrative and not restrictive. The protection scope of the present specification should be interpreted in accordance with the scope of the claims, and all technical spirits within the equivalent scope should be interpreted as being included in the scope of rights of the present specification.

What is claimed is:

1. An electrolyte composite comprising:
a solid electrolyte green sheet;
a first composite membrane laminated over a first surface of the solid electrolyte green sheet; and
a second composite membrane laminated over a second surface of the solid electrolyte green sheet,
wherein the electrolyte composite has a thickness of 30 μm or less.

2. The electrolyte composite of claim 1,
wherein the electrolyte composite has an ionic conductivity of at least 5×10⁻⁵ S/m.

3. The electrolyte composite of claim 1,
wherein the solid electrolyte green sheet has a thickness of 5 to 20 μm,
wherein the first composite membrane has a thickness of 1 to 5 μm, and
the second composite membrane has a thickness of 1 to 5 μm.

4. The electrolyte composite of claim 1, wherein
the solid electrolyte green sheet comprising a mixture of a solid electrolyte and a binding agent,
wherein the solid electrolyte comprises 60 to 95 wt % of the mixture and
wherein the binding agent comprises 5 to 40 wt %, and
further wherein the solid electrolyte comprises an ion-conductive garnet-type oxide having an average particle diameter (D₅₀) of 10 μm or less and which comprises a compound represented by a chemical formula corresponding to one of i) to iii) below:
i) Li₇₋ₓMₓLa₃Zr₂₋ₓO₁₂ (wherein M is at least one element selected from the group consisting of Ga, Ta, Y, Sc, Nb, Fe, and Al, and x≤0.7),
ii) LiₓGa_{w}La_{y}Zr_{z}O₁₂ (wherein 5≤x≤9, 2≤y≤4, 1≤z≤3, and 0≤w≤1), and
iii) LiₓGa_{w}La_{y}Zr_{z}ScₘO₁₂ (wherein 5≤x≤9, 2≤y≤4, 1≤z≤3, 0≤w≤1, and 0≤m≤1).

5. The electrolyte composite of claim 1, wherein
each of the first composite membrane and the second composite membrane contains an ion-conductive oxide and an ion-conductive polymer, and
the ion-conductive oxide comprises an ion-conductive garnet-type oxide having an average particle diameter (D₅₀) of 2 μm or less, which comprises a compound represented by a chemical formula corresponding to one of i) to iii) below:
i) Li₇₋ₓMₓLa₃Zr₂₋ₓO₁₂ (wherein M is at least one atom selected from the group consisting of Ga, Ta, Y, Sc, Nb, Fe, and Al, and wherein x≤0.7),
ii) LiₓGa_{w}La_{y}Zr_{z}O₁₂ (wherein 5≤x≤9, 2≤y≤4, 1≤z≤3, and 0≤w≤1), and
iii) LiₓGa_{w}La_{y}Zr_{z}ScₘO₁₂ (wherein 5≤x≤9, 2≤y≤4, 1≤z≤3, 0≤w≤1, and 0≤m≤1).

6. The electrolyte composite of claim 1, wherein
a ratio A: B of a thickness (A) of the solid electrolyte green sheet and a cumulative thickness (B) of both the first composite membrane and the second composite membrane is 1:0.2 to 1:1.5.

7. An all-solid-state battery comprising:
a positive electrode;
a negative electrode; and
an electrolyte,
wherein the electrolyte comprises the electrolyte composite of claim 1.

8. A method of preparing an electrolyte composite, comprising steps of:
(S1) preparing a solid electrolyte green sheet;
(S2) preparing a first composite membrane comprising an ion-conductive oxide and an ion-conductive polymer and a second composite membrane comprising an ion-conductive oxide and an ion-conductive polymer;
(S3) laminating the first composite membrane over a first main surface of the solid electrolyte green sheet to obtain a first laminate;
(S4) impregnating a second main surface of the green sheet of the first laminate with a mixture comprising a lithium salt and a plasticizer and drying the mixture to obtain a modified first laminate; and
(S5) laminating the second composite membrane over the second main surface of the modified first laminate, wherein the electrolyte composite has a total thickness of 30 μm or less.

9. The method of claim 8, wherein
the solid electrolyte green sheet has a thickness of 5 to 20 μm,
the first composite membrane has a thickness of 1 to 5 μm, and
the second composite membrane has a thickness of 1 to 5 μm.

10. The method of claim 8, wherein a ratio A: B of a thickness (A) of the solid electrolyte green sheet and a cumulative thickness (B) of the first composite membrane and the second composite membrane is 1:0.2 to 1:1.5.

11. The method of claim 8, wherein
preparing the solid electrolyte green sheet in the step (S1) further comprises preparing a mixture from which the solid electrolyte green sheet is formed wherein the mixture consisting essentially of 60 to 95 wt % of a solid electrolyte and 5 to 40 wt % of a binding agent.

12. The method of claim 11, wherein
the solid electrolyte comprises an ion-conductive garnet-type oxide having an average particle diameter (D₅₀) of 10 μm or less, which comprises a compound represented by a chemical formula corresponding to one of i) to iii) below:
i) Li₇₋ₓMₓLa₃Zr₂₋ₓO₁₂ (wherein M is at least one selected from a group consisting of Ga, Ta, Y, Sc, Nb, Fe and Al, and x≤0.7),
ii) LiₓGa_{w}La_{y}Zr_{z}O₁₂ (wherein 5≤x≤9, 2≤y≤4, 1≤z≤3, and 0≤w≤1), and
iii) LiₓGa_{w}La_{y}Zr_{z}ScₘO₁₂ (wherein 5≤x≤9, 2≤y≤4, 1≤z≤3, 0≤w≤1, and 0≤m≤1).

13. The method of claim 11, wherein
the binding agent contains an agent selected from the group consisting of cellulose, polyvinylidene fluoride (PVDF), polyvinylidene fluoride-hexafluoro propylene (PVDF-HFP), polyacrylonitrile (PAN), polyethylene oxide (PEO), and mixtures thereof.

14. The method of claim 8, wherein
preparing the first composite membrane further comprises applying a layer of a first mixture comprising an ion-conductive oxide, an ion-conductive polymer, a lithium salt, and a plasticizer, applying the mixture onto a release film and drying the first mixture; and
preparing the second composite membrane comprises applying a layer of a second mixture comprising an ion-conductive oxide, an ion-conductive polymer, a lithium salt, and a plasticizer, onto a release film, and drying the second mixture.

15. The method of claim 8, wherein
the ion-conductive oxide comprises an ion-conductive garnet-type oxide having an average particle diameter (D₅₀) of 2 μm or less, which contains a compound represented by a chemical formula corresponding to one of i) to iii) below:
i) Li₇₋ₓMₓLa₃Zr₂₋ₓO₁₂ (wherein M is at least one selected from a group consisting of Ga, Ta, Y, Sc, Nb, Fe and Al, and x≤0.7),
ii) LiₓGa_{w}La_{y}Zr₂₀₁₂ (wherein 5≤x≤9, 2≤y≤4, 1≤z≤3, and 0≤w≤1), and
iii) LiₓGa_{w}La_{y}Zr₂ScₘO₁₂ (wherein 5≤x≤9, 2≤y≤4, 1≤z≤3, 0≤w≤1, and 0≤m≤1).

16. The method of claim 8, wherein the ion-conductive polymer comprises a polymer selected from the group consisting of polyvinylidene fluoride-hexafluoro propylene (PVDF-HFP), polyvinylidene fluoride (PVDF), polyacrylonitrile (PAN), polyethylene oxide (PEO), and copolymers and mixtures thereof.

17. The method of claim 8, wherein the lithium salt is selected from the group consisting of lithium bistrifluoromethanesulfonyl imide (LiFSI), lithium hexafluorophosphate (LiPF₆), lithium tetrafluoroborate (LiBF₄), lithium hexafluoroantimonate (LiSbF₆), lithium Hexafluoroacenate (LiAsF₆), lithium difluoromethanesulfonate (LiC₄F₉SO₃), lithium perchlorate (LiClO₄), lithium aluminate (LiAlO₂), lithium tetrachloroaluminate (LiAlCl₄), lithium chloride (LiCl), lithium iodide (LiI), lithium bisoxalate borate (LiB(C₂O₄)₂), lithium trifluoromethanesulfonylimide (LiTFSI), and mixtures thereof.

18. The method of claim 8, wherein the plasticizer is selected from the group consisting of succinonitrile (ScN), alkylene carbonate containing 1 to 4 carbon atoms, vinylene carbonate, dimethyl carbonate, diethyl carbonate, methyl ethyl carbonate, gammabutyrolactone, sulfolane, 1,2-dimethoxyethane, 1,2-diethoxyethane, 1,2-ethoxymethoxyethane, tetrahydrofuran, 2-methyl-1,3-dioxolane, 4-methyl-1,3-dioxolane, dimethyl ether, diethyl ether, methyl propionate, and mixtures thereof.

19. The method of claim 14, further comprising:
removing the release film from the first composite membrane after preparing the first laminate.

20. The method of claim 8, wherein,
the mixture applied to the second main surface of the green sheet of the first laminate comprises a molar ratio of the lithium salt to the plasticizer of 1:8 to 1:30.
